(19) United States
(12) Patent Application Publication
(10) Pub. No.: US 2010/0121763 A1
(43) Pub. Date: May 13, 2010

(54) Method and apparatus to facilitate using a virtual-world interaction to facilitate a real-world transaction

(75) Inventors: Venugopal Vasudevan, Palatine, IL (US); John D. Bruner, South Barrington, IL (US)

Correspondence Address: MOTOROLA/FETF, 120 SOUTH LASALLE STREET, SUITE 1600, CHICAGO, IL, 60603-3406, US

(73) Assignee: Motorola, Inc., Schaumburg, IL (US)

(21) Appl. No.: 12/270,508

(22) Filed: Nov. 13, 2008

(51) Int. Cl. G06Q 20/00; G06F 3/048; G06Q 30/00

(52) U.S. Cl. 705/39; 715/757

(57) ABSTRACT

One presents (101) a virtual-world representation of a first real-world individual as engaged in a real-world activity. One then detects (102) an interaction of a virtual-world representation of a second real-world individual with the virtual-world representation of the first real-world individual and, in response (103) to this interaction, facilitates a real-world transaction as pertains to the given real-world activity for the benefit of the second real-world individual.

### TECHNICAL FIELD

This invention relates generally to real-world transactions and virtual-world representations.

### BACKGROUND

Real-world transactions are well known in the art. The expression “real-world” will be understood to refer to the realm of human experience comprising physical objects (exclusive of theoretical constructs, hypotheses, artificial environments, and virtual-worlds that are generated and sustained via computer simulation). The expression “transactions,” in turn, will be understood to refer to acts of conducting or otherwise carrying out one's business, plans, or the like. In one simple example of a real-world transaction, one individual meets face-to-face, in person, with another individual and makes an exchange between them of an item or a service in return for some acceptable consideration.

Virtual-world representations are also well known in the art. As used herein, the expression “virtual-world” will be understood to refer to a computer-based simulated environment intended for its users to inhabit and interact via avatars. These avatars are usually depicted as textual, two-dimensional, or three-dimensional graphical representations, although other forms are possible. Some virtual worlds allow for multiple users and in many cases permit the user to manipulate elements of the modeled world. Such modeled worlds may appear similar to the real world or may instead depict fantasy worlds.

It is also known to provide a virtual-world representation of a virtual-world transaction. For example, in some cases one user's avatar in a given virtual world can exchange a virtual-world currency for a given virtual-world service or item. What—is considerably less developed, however, is a useful intersection between real-world transactions and virtual-world representations. What few examples exist in this regard tend to be simplistic, unconvincing, non-subtle, inflexible, and ultimately non-compelling to the participating parties. This, in turn, can lead to user disinterest or worse.

### BRIEF DESCRIPTION OF THE DRAWINGS

The above needs are at least partially met through provision of the method and apparatus to facilitate using a virtual-world interaction to facilitate a real-world transaction described in the following detailed description, particularly when studied in conjunction with the drawings, wherein:

FIG. 1 comprises a flow diagram as configured in accordance with various embodiments of the invention;

FIG. 2 comprises a block diagram as configured in accordance with various embodiments of the invention; and

FIG. 3 comprises a block diagram as configured in accordance with various embodiments of the invention.

Skilled artisans will appreciate that elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. It will further be appreciated that certain actions and/or steps may be described or depicted in a particular order of occurrence while those skilled in the art will understand that such specificity with respect to sequence is not actually required. It will also be understood that the terms and expressions used herein have the ordinary technical meaning as is accorded to such terms and expressions by persons skilled in the technical field as set forth above except where different specific meanings have otherwise been set forth herein.

### DETAILED DESCRIPTION

Generally speaking, pursuant to these various embodiments, one presents a virtual-world representation of a first real-world individual as engaged in a real-world activity. One then detects an interaction of a virtual-world representation of a second real-world individual with the virtual-world representation of the first real-world individual and, in response to this interaction, facilitates a real-world transaction as pertains to the given real-world activity for the benefit of the second real-world individual.

By one approach, this can correspond to a current virtual-world representation of the first real-world individual who is presented engaged in the given real-world activity. The detected interaction can correspond, if desired, to an interaction between the second real-world individual and their end user apparatus. By one approach, the detected interaction can comprise a detected expression of interest on the part of the second real-world individual in the virtual-world representation of the given real-world activity. This expression of interest can be relatively subtle and nuanced if desired (such as, but not limited to, a particular gesture or the like).

These teachings will readily accommodate also presenting a virtual-world representation of the interaction of the second real-world individual with the virtual-world representation of the first real-world individual as well as providing real-world compensation (for example, from the second real-world individual) on behalf of the first real-world individual as a function of facilitating the real-world transaction.

So configured, those skilled in the art will recognize and appreciate that these teachings are readily implemented using a variety of existing platforms. It will also be appreciated that these teachings are highly scalable as well as highly leverageable and can be successfully applied with a great number of virtual-world representations and an almost limitless number of real-world activities and desired real-world transactions.

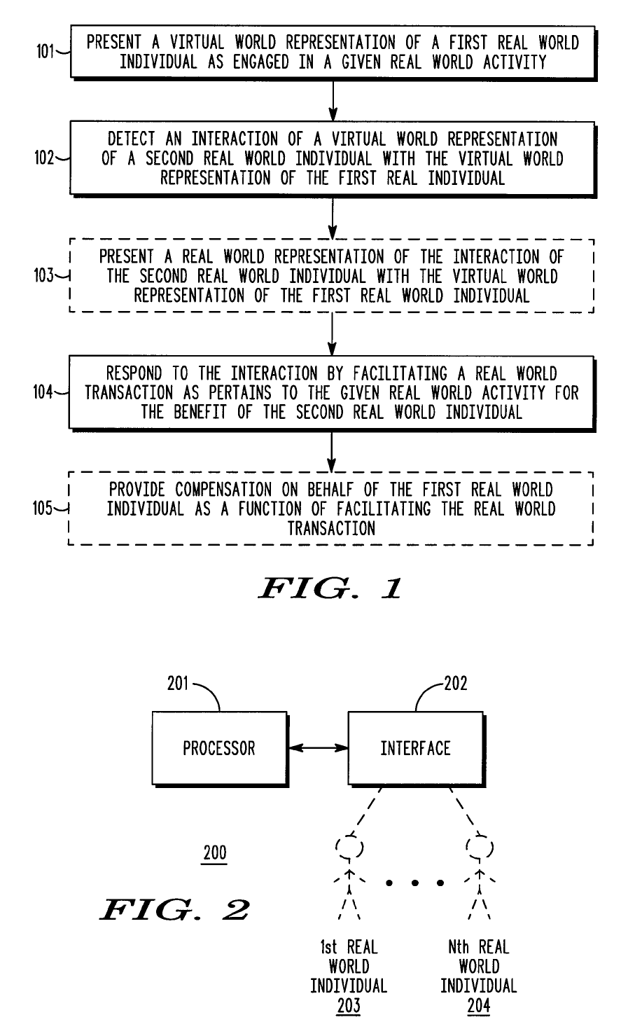

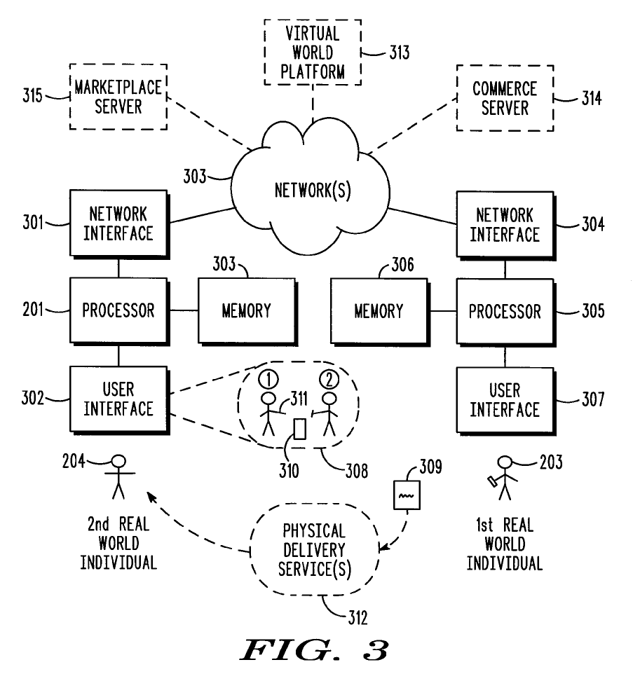

These and other benefits may become clearer upon making a thorough review and study of the following detailed description. Referring now to the drawings, and in particular to FIG. 1, an illustrative process that is compatible with many of these teachings will now be presented.

This process 100 includes the step 101 of presenting a virtual-world representation of a first real-world individual as engaged in a given real-world activity. This presentation can occur, for example, at an end user apparatus that is presently being used by a second real-world individual. Examples in this regard might include, but are not limited to, a cellular telephone, a wireless push-to-talk two-way communications device, a personal digital assistant (PDA), a laptop or desktop personal computer, and so forth.

This virtual-world representation of a first real-world individual as engaged in a given real-world activity will be understood to comprise a virtual representation of a real person doing something in the real-world. By one approach, this can comprise a substantially current virtual-world representation of this individual who is presently engaged in this real-world activity. (As used herein, “substantially current” will be understood to refer to a time frame that is at least close to when the real-world activity is occurring but which makes allowance for a certain amount of delay (such as 0.5 seconds, 1 second, 2 seconds, 5 seconds, or the like) to accommodate such things as sensor data gathering, processing, and interpreting, virtual representation of the real-world activity, and propagation delays, to note but a few examples in this regard.)

Those skilled in the art will recognize that this virtual-world representation of a first real-world individual can comprise using an avatar that presents an as-realistic or an as-unrealistic representation as may be desired to suit the needs and/or opportunities as tend to characterize a given application setting. It will also be understood that this representation can be completely graphic in nature, completely alphanumeric in nature, or some combination of both.

These teachings will also accommodate accompanying this visual representation of the first real-world individual with corresponding audio content. By one approach, for example, this audio content can comprise spoken content as sourced by the first real-world individual themselves. This spoken content can comprise, for example, substantially real-time streaming of the words being spoken by the first real-world individual as their virtual-world representation is being presented.

This process 100 also provides the step 102 of detecting an interaction of a virtual-world representation of the aforementioned second real-world individual with the virtual-world representation of the first real-world individual. This step can be facilitated, for example, at least in part by detecting a corresponding interaction between this second real-world individual and their aforementioned end user apparatus. This may comprise detecting a direct interaction (as when the second real-world individual specifically manipulates a given control surface on the end user apparatus such as a touch screen, a button, a switch, a joystick or other cursor control mechanism, and so forth). This may also comprise, if desired, detecting an indirect interaction (as when the end user apparatus includes a gesture recognition capability, a gaze directionality detection capability, and so forth).

By one approach, and apropos to many anticipated useful application settings, this step of detecting an interaction can comprise detecting an expression of interest on the part of the second real-world individual in the virtual-world representation of the given real-world activity. This can comprise, for example, the second real-world individual moving a cursor to highlight some particular element of the virtual-world representation and selecting that highlighted element via, for example, a click. As another illustrative non-limiting example in this regard, this could also comprise detecting the end user's gaze directionality and determining when the end user's gaze remains on a particular component of the virtual-world representation for more than some predetermined period of time. Those skilled in the art will recognize that numerous other possibilities exist in this regard and that other approaches will no doubt be developed going forward.

If desired, these teachings will optionally accommodate the step 103 of also presenting a virtual-world representation of this interaction of the second real-world individual with the virtual-world representation of the first real-world individual. This virtual-world representation of the interaction can be provided, for example, to the second real-world individual via the aforementioned virtual-world representation in order to facilitate the making of this interaction as per the wishes of the second real-world individual. It would also be possible to offer this virtual-world representation of the interaction to the first real-world individual and/or to other third parties. These third parties might comprise, for example, other inhabitants or active participants in the corresponding virtual world.

This process 100 then provides the step 104 of responding to this interaction by facilitating a real-world transaction as pertains to the given real-world activity for the benefit of the second real-world individual. This can comprise, for example, providing the second real-world individual with a given real-world item or service as pertains to the given real-world activity. By one approach, if desired, this real-world transaction can correspond generally (or correlate directly, if desired) to universally (or at least culturally) accepted social interpretations of the virtual world interaction. For example, by having one avatar hand over a virtual item to a second avatar, this can correspond to a universally and culturally-accepted notion that the first avatar is lending or selling this item to the second avatar (depending in some cases, of course, on other activity context as may accompany, precede, or follow this interaction).

When this given real-world activity includes, for example, a transfer of possession of a given real-world object (such as a book), completion of this real-time activity could be verified digitally or by such other means as may be appropriate to the needs and/or opportunities that tend to characterize a given application setting. These teachings will also accommodate, if desired, the use of one or more third party intermediaries (such as third parties who serve an escrow functionality) that may, or may not, have a virtual representation in the virtual world setting as desired.

These teachings will optionally further provide the step 105 of providing compensation on behalf of the first real-world individual as a function of facilitating this real-world transaction. By one approach, for example, this can comprise providing real-world compensation (such as payment via an exchange of currency, the proffering of a negotiable check or other similar instrument, the making of a charge on a corresponding credit or debit account, and so forth) to the first real-world individual. By another approach, if desired, this can comprise providing virtual-world compensation to the virtual-world representation of the first real-world individual (such as by a shifting of a given virtual-world's local medium of exchange from an account for the second real-world individual to an account for the first real-world individual).

Those skilled in the art will appreciate that the above-described processes are readily enabled using any of a wide variety of available and/or readily configured platforms, including partially or wholly programmable platforms as are known in the art or dedicated purpose platforms as may be desired for some applications. Referring now to FIG. 2, an illustrative approach to such a platform will now be provided.

The illustrated apparatus 200 (which might comprise, for example, any of the aforementioned candidate end user platforms) can comprise a processor 201 that operably couples to an interface 202 that facilitates the aforementioned interactions with a first through an Nth real-world individual 203 and 204 (where “N” will be understood to comprise an integer greater than one and may comprise, in a simplest example, the value two). Those skilled in the art will recognize and appreciate that such a processor 201 can comprise a fixed-purpose hard-wired platform or can comprise a partially or wholly programmable platform. It will also be understood that this view of the processor 201 can be taken as a logical view, in which case the corresponding functionality can be distributed over a plurality of separate physical platforms. All of these architectural options are well known and understood in the art and require no further description here.

This processor 201 can be configured (using, for example, programming as will be well understood by those skilled in the art) to carry out one or more of the steps, actions, and functionality described herein. This can comprise in particular, for example, presenting the virtual-world representation of the first real-world individual as engaged in the given real-world activity, detecting the interaction of a virtual-world representation of the second real-world individual with the virtual-world representation of the first real-world individual, and responding to that interaction by facilitating a real-world transaction as pertains to the given real-world activity for the benefit of the second real-world individual.

Those skilled in the art will recognize and understand that such an apparatus 200 may be comprised of a plurality of physically distinct elements as is suggested by the illustration shown in FIG. 2 It is also possible, however, to view this illustration as comprising a logical view, in which case one or more of these elements can be enabled and realized via a shared platform. It will also be understood that such a shared platform may comprise a wholly or at least partially programmable platform as are known in the art.

For the sake of illustration, and with no intention of suggesting any particular limitations in these regards, a more particular instantiation in accord with these teachings will now be presented using an application setting having a first real-world individual 203 and a second real-world individual 204. In this example, the first real-world individual 203 is a well-known author who is engaged in the real-world activity of autographing copies of their latest novel.

At least some of the activities of this first real-world individual 203 are noted, captured, and/or otherwise identified via, for example, an end user platform that comprises a processor 305 that operably couples to a memory 306 and a user interface 307. This memory can serve to store, for example, the computer instructions that are used, at least in part, to translate the (direct and/or indirect) inputs of the first real-world individual 203 into corresponding virtual-world corollaries and/or representations. There are numerous approaches to achieving this result which are known in the art. As these teachings are not overly sensitive to any particular selection in this regard, for the sake of brevity and the preservation of clarity, further elaboration in this regard will not be presented here.

This processor 305 also operably couples to a network interface 304 that in turn couples to and interacts compatibly with one or more intervening networks 303. Exemplary networks include, but are not limited to, proprietary intranets, cellular telephony networks, and the Internet itself.

The second real-world individual 204, in turn, is able to view a rendering of a virtual-world representation 308 of the first real-world individual via a platform that comprises, in this illustrative example, a processor 201 as described above. This processor 201 operably couples to a network interface 301 (which couples to the aforementioned network(s) 303). This processor 201 also operably couples to a memory 303 and a user interface 302. In this particular illustrative embodiment, this user interface 302 comprises, at least in part, a display to provide a visual rendering of the aforementioned virtual-world representation 308. The memory 303, in turn, can again serve to store some or all of the programming being used by the processor 201 and/or other instructional or data content as may serve these purposes.

In this illustrative example, as the first real-world individual 203 interacts with a book 309, the virtual-world representation 308 provides, substantially in real time, a corresponding virtual-world representation of that particular real-world activity. As a simple example in this regard, when the first real-world individual 203 picks up the book 309 in real life, the virtual-world representation 308 provides a depiction of an avatar for the first real-world individual doing the same with a virtual representation 310 of the book.

As noted above, in this illustrative example, the first real-world individual 203 is a novelist who is autographing copies of his or her novel at a given real-world bookstore. To now be more specific, this author is providing this benefit for people who purchase a copy of the novel at this time (or within, for example, some given preceding period of time such as within the past two hours or so).

With this in mind, and to continue with this illustrative scenario, the second real-world individual 204 effects some action via their corresponding user interface 302 to thereby indicate a desire to purchase one of these books and to have it autographed by the author. In this example, this action results in an avatar of the second real-world individual gesturing 311, in the virtual-world representation 308, to express this particular interest. These teachings then provide for detecting such an interaction between these elements of the virtual-world and to respond, in turn, by facilitating having the first real-world individual 203 signing, in the real world, a real-world copy of the book 309. This signing can occur at the time of purchase, by one approach, or the signing can follow the purchasing activity by having the second real-world individual “stand” in a virtual queue with other purchasers to await their turn to have their book signed by the author. At the same time, of course, a virtual representation of this activity can be provided as well, thereby allowing the second real-world individual 204 to experience (albeit virtually) this activity and moment.

The physical book 309, now signed by the author, can now be delivered via one or more intervening physical delivery services 312 of choice to the second real-world individual 204. Examples in this regard can include, but are not limited to, the United States Postal Service, the United Parcel Service, Federal Express, and so forth. These teachings would also accommodate additional services in this regard if desired. For example, the second real-world individual 204 can be provided with an opportunity to download a digital copy of the book and/or such a digital copy can be pushed to the second real-world individual 204 via a delivery technique of choice.

As noted earlier, these teachings will readily accommodate an exchange of consideration in support of such a transaction. To illustrate, in this particular example the second real-world individual 204 could first be required to make a payment via a service such as Paypal when seeking to purchase a signed copy of the book as described. This financial service could then aggregate such amounts into an account on behalf of the first real-world individual 203. To facilitate such an approach, one may rely upon, for example, a commerce server 314 of choice. This can include, but is not limited to, credit and debit transaction authorization hosts, Paypal-like servers, and so forth.

In many cases it is anticipated that the end user platform will not itself support and host the virtual-world representation (at least not fully). Instead, one or more virtual-world platform servers 313 can be accessed and relied upon in this regard. Present examples in this regard would include, but are not limited to, the Second Life virtual world servers.

Similarly, and as will be understood by those skilled in the art, numerous other servers can be relied upon as desired to meet one or more of the described purposes and/or to supplement these teachings with additional functionality, capabilities, and services. As but one example in this regard, a marketplace server 315 may serve in the present example to facilitate the availability of books to be signed and the packaging and forwarding of signed books via a given physical delivery service to the purchasing party. Numerous other possibilities will readily come to mind of those skilled in the art. As but one illustrative example in this regard, an ebook ecosystem as facilitated by Amazon's Kindle platform would support providing a digital copy of a given book to a purchaser that bears a digital signature from the author along with, for example, a personalized message from the author as well.

So configured, those skilled in the art will recognize and appreciate that these teachings are readily implemented using commonly available platforms and services (including any of a wide variety of virtual-world settings). It will further be recognized that these teachings would serve to greatly leverage the existing capabilities and functionality of such platforms. Furthermore, it will be appreciated that these teachings are highly scalable and can readily serve in any of a wide variety of real-world activities in support of any of a wide variety of real-world transactions.

Those skilled in the art will recognize that a wide variety of modifications, alterations, and combinations can be made with respect to the above described embodiments without departing from the spirit and scope of the invention, and that such modifications, alterations, and combinations are to be viewed as being within the ambit of the inventive concept.

We claim:

1. A method comprising:
presenting a virtual-world representation of a first real-world individual as engaged in a given real-world activity;
detecting an interaction of a virtual-world representation of a second real-world individual with the virtual-world representation of the first real-world individual;
responding to the interaction by facilitating a real-world transaction as pertains to the given real-world activity for the benefit of the second real-world individual.

2. The method of claim 1 wherein presenting a virtual-world representation of a first real-world individual as engaged a given real-world activity comprises presenting a substantially current virtual-world representation of a first real-world individual as presently engaged a given real-world activity.

3. The method of claim 1 wherein presenting a virtual-world representation of a first real-world individual as engaged a given real-world activity comprises presenting the virtual-world representation at an end user apparatus that is being presently used by the second real-world individual.

4. The method of claim 3 wherein detecting an interaction of a virtual-world representation of a second real-world individual with the virtual-world representation of the first real-world individual comprises detecting an interaction between the second real-world individual and the end user apparatus.

5. The method of claim 4 wherein detecting an interaction of a virtual-world representation of a second real-world individual with the virtual-world representation of the first real-world individual comprises detecting an expression of interest on the part of the second real-world individual in a virtual-world representation of the given real-world activity.

6. The method of claim 1 further comprising:
presenting a virtual-world representation of the interaction of the second real-world individual with the virtual-world representation of the first real-world individual.

7. The method of claim 1 wherein responding to the interaction by facilitating a real-world transaction as pertains to the given real-world activity for the benefit of the second real-world individual comprises providing the second real-world individual with a given real-world item as pertains to the given real-world activity.

8. The method of claim 1 further comprising:
providing compensation on behalf of the first real-world individual as a function of facilitating the real-world transaction.

9. The method of claim 8 wherein providing compensation comprises at least one of:
providing real-world compensation to the first real-world individual; and
providing virtual-world compensation to the virtual-world representation of the first real-world individual.

10. An apparatus comprising:
an interface to facilitate interacting with a first and a second real-world individual;
a processor operably coupled to the interface and being configured and arranged to:
present a virtual-world representation of the first real-world individual as engaged a given real-world activity;
detect an interaction of a virtual-world representation of the second real-world individual with the virtual-world representation of the first real-world individual;
respond to the interaction by facilitating a real-world transaction as pertains to the given real-world activity for the benefit of the second real-world individual.

11. The apparatus of claim 10 wherein the processor is further configured and arranged to present a virtual-world representation of a first real-world individual as engaged a given real-world activity by presenting a substantially current virtual-world representation of a first real-world individual as presently engaged a given real-world activity.

12. The apparatus of claim 10 wherein the processor is further configured and arranged to present a virtual-world representation of a first real-world individual as engaged a given real-world activity by presenting the virtual-world representation at an end user apparatus that is being presently used by the second real-world individual.

13. The apparatus of claim 12 wherein the processor is further configured and arranged to detect an interaction of a virtual-world representation of a second real-world individual with the virtual-world representation of the first real-world individual by detecting an interaction between the second real-world individual and the end user apparatus.

14. The apparatus of claim 13 wherein the processor is further configured and arranged to detect an interaction of a virtual-world representation of a second real-world individual with the virtual-world representation of the first real-world individual by detecting an expression of interest on the part of the second real-world individual in a virtual-world representation of the given real-world activity.

15. The apparatus of claim 10 wherein the processor is further configured and arranged to present a virtual-world representation of the interaction of the second real-world individual with the virtual-world representation of the first real-world individual.

16. The apparatus of claim 10 wherein the processor is further configured and arranged to respond to the interaction by facilitating a real-world transaction as pertains to the given real-world activity for the benefit of the second real-world individual by providing the second real-world individual with a given real-world item as pertains to the given real-world activity.

17. The apparatus of claim 10 wherein the processor is further configured and arranged to provide compensation on behalf of the first real-world individual as a function of facilitating the real-world transaction.

18. The apparatus of claim 17 wherein the processor is further configured and arranged to provide compensation by at least one of:
providing real-world compensation to the first real-world individual; and
providing virtual-world compensation to the virtual-world representation of the first real-world individual.
